(19) United States
(12) Patent Application Publication
(10) Pub. No.: US 2026/0167808 A1
(43) Pub. Date: Jun. 18, 2026

(54) RUBBER COMPOSITION AND TIRE

(71) Applicant: Toyo Tire Corporation, Itami-shi (JP)

(72) Inventors: Hama Kanaya, Itami-shi (JP); Shun Umemiya, Itami-shi (JP)

(73) Assignee: Toyo Tire Corporation, Itami-shi (JP)

(21) Appl. No.: 19/416,125

(22) Filed: Dec. 11, 2025

(30) Foreign Application Priority Data
Dec. 13, 2024 (JP) 2024-218408

(51) Int. Cl. C08L 15/00; B60C 1/00; B60C 11/00

(52) U.S. Cl. CPC C08L 15/00; B60C 1/0016; B60C 11/0008; B60C 2011/0016; C08L 2312/00

(57) ABSTRACT

The rubber composition according to an embodiment contains a rubber component containing a modified solution-polymerized styrene butadiene rubber, silica, and a thiuram-based vulcanization accelerator represented by the following general formula (1). Based on 100 parts by mass of the rubber component, the silica content is 80 to 140 parts by mass, and the thiuram-based vulcanization accelerator content is 0.2 to 6 parts by mass. In the formula (1), R¹, R², R³, and R⁴ are each independently a hydrocarbon group having 12 to 20 carbon atoms and may contain one heteroatom or more, and R¹ and R² and/or R³ and R⁴ may form a heterocyclic group together with the nitrogen atom to which they are bonded.

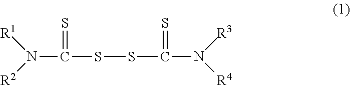

### BACKGROUND OF THE INVENTION

### 1. Field of the Invention

The present invention relates to a rubber composition and a tire using the same.

### 2. Description of Related Art

To improve the low fuel efficiency of tires, it has been examined to blend silica as a filler in a rubber composition used for tires. Silica can improve the low heat generation property of a rubber composition and contribute to the low fuel efficiency. However, in general, it is more difficult to evenly disperse silica in a rubber composition than carbon black.

JP2003-535943A discloses that a thiuram disulfide is used in a silica-compounded rubber composition as a vulcanization accelerator instead of diphenylguanidine and that the Mooney scorch value is increased as a result.

WO2006/028254 discloses that an alkoxysilane coupling agent having a mercapto group and a thiuram disulfide-based vulcanization accelerator are used in combination in a silica-compounded rubber composition to simultaneously solve the problems of the retarded vulcanization and the dispersibility of silica.

JP2002-265686A discloses that a tetrakis(alkyl)thiuram disulfide is added as a vulcanization accelerator based on vulcanization to a rubber composition containing a styrene butadiene rubber and that the addition prevents generation of a toxic nitrosamine and a decrease in the physical properties of rubber.

### SUMMARY OF THE INVENTION

As shown above, although it is known that a thiuram disulfide is blended as a vulcanization accelerator in a silica-compounded rubber composition, there is still room for improvement in the low heat generation property.

In view of the above point, an object of an embodiment of the invention is to provide a rubber composition which can improve the dispersibility of silica and improve the low heat generation property and to provide a tire using the same.

The invention includes the embodiments shown below.

[1]A rubber composition containing a rubber component containing a modified solution-polymerized styrene butadiene rubber, silica, and a thiuram-based vulcanization accelerator represented by the following general formula (1)

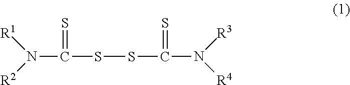

in which in the formula (1), R¹, R², R³, and R⁴ are each independently a hydrocarbon group having 12 to 20 carbon atoms and may contain one heteroatom or more, where R¹ and R² and/or R³ and R⁴ may form a heterocyclic group together with the nitrogen atom to which they are bonded, and
based on 100 parts by mass of the rubber component, the silica content is 80 to 140 parts by mass, and the thiuram-based vulcanization accelerator content is 0.2 to 6 parts by mass.

[2] The rubber composition according to [1] in which the modified solution-polymerized styrene butadiene rubber is a solution-polymerized styrene butadiene rubber into which at least one functional group selected from the group consisting of an amino group, a hydroxy group, an alkoxy group, a silyl group, an alkoxysilyl group, an epoxy group, and a carboxy group has been introduced.

[3] The rubber composition according to [1] or [2] in which 100 parts by mass of the rubber component contain 50 to 90 parts by mass of the modified styrene butadiene rubber and 10 to 50 parts by mass of at least one selected from the group consisting of a natural rubber, a synthetic isoprene rubber, and a butadiene rubber.

[4] The rubber composition according to [1] or [2] in which 100 parts by mass of the rubber component contain 50 to 90 parts by mass of the modified styrene butadiene rubber and 10 to 50 parts by mass of a butadiene rubber.

[5] The rubber composition according to any one of [1] to [4] in which the silica content is 90 to 130 parts by mass based on 100 parts by mass of the rubber component.

[6] The rubber composition according to any one of [1] to [5] in which R¹, R², R³, and R⁴ in the formula (1) each independently represent a linear or branched alkyl group having 12 to 18 carbon atoms.

[7] The rubber composition according to any one of [1] to [5] in which R¹, R², R³, and R⁴ in the formula (1) each independently represent a linear alkyl group having 12 to 18 carbon atoms.

[8] The rubber composition according to any one of [1] to [7] which further contains a sulfenamide-based vulcanization accelerator and in which the sulfenamide-based vulcanization accelerator content is 0.2 to 6 parts by mass based on 100 parts by mass of the rubber component and the mass ratio of the thiuram-based vulcanization accelerator content to the sulfenamide-based vulcanization accelerator content is 1/6 to 4/1.

[9] The rubber composition according to any one of [1] to [8] which is a rubber composition for a tire.

[10]A tire having a rubber member produced with the rubber composition according to any one of [1] to [9].

[11]A tire having a tread rubber produced with the rubber composition according to any one of [1] to [9].

According to an embodiment of the invention, the dispersibility of silica can be improved, and the low heat generation property can be improved.

### DESCRIPTION OF EMBODIMENTS

The rubber composition according to the embodiment contains a rubber component containing a modified solution-polymerized styrene butadiene rubber, silica, and a specific thiuram-based vulcanization accelerator.

The modified solution-polymerized styrene butadiene rubber (modified SSBR) is a styrene butadiene rubber which is obtained by anionic polymerization in an organic solvent and is a rubber modified with a functional group which has been introduced in the terminal and/or the main chain.

The functional group is preferably a functional group which interacts with silica, preferably a functional group containing at least one selected from the group consisting of an oxygen atom, a nitrogen atom, and a silicon atom, more preferably a functional group containing an oxygen atom and/or a nitrogen atom. Specific examples of the functional group include at least one selected from the group consisting of an amino group, a hydroxy group, an alkoxy group, a silyl group, an alkoxysilyl group, an epoxy group, and a carboxy group. When modified SSBR having such a functional group is used, the effect of improving the dispersibility of silica can be enhanced.

The rubber component may be composed of modified SSBR alone but may contain another diene rubber with modified SSBR. The amount of the modified SSBR in 100 parts by mass of the rubber component may be, for example, 30 parts by mass or more, 50 parts by mass or more, 60 parts by mass or more, 70 parts by mass or more or 100 parts by mass.

Examples of the other diene rubber include a natural rubber (NR), a synthetic isoprene rubber (IR), a butadiene rubber (BR), unmodified SSBR, an emulsion-polymerized styrene butadiene rubber (ESBR), a nitrile rubber (NBR), a chloroprene rubber (CR), a styrene-isoprene copolymer rubber, a butadiene-isoprene copolymer rubber, a styrene-isoprene-butadiene copolymer rubber, and the like. The concept of these diene rubbers also includes those in which the terminal or the main chain has been modified according to the need (for example, terminal-modified BR) and those modified to add a desired feature (for example, modified NR). Any one kind of these other diene rubbers may be used, or two or more kinds thereof may be used in combination. Here, the diene rubber refers to a rubber having a repeating unit corresponding to a diene monomer having a conjugated double bond and contains a carbon-carbon double bond in the main chain of the polymer. The diene rubber content of the rubber component is preferably 80 mass % or more, more preferably 90 mass % or more, and may be 100 mass %.

In an embodiment, 100 parts by mass of the rubber component may contain 50 to 90 parts by mass of modified SSBR and 10 to 50 parts by mass of at least one selected from the group consisting of NR, IR, and BR (preferably BR). Moreover, 100 parts by mass of the rubber component may contain 60 to 80 parts by mass of modified SSBR and 20 to 40 parts by mass of at least one selected from the group consisting of NR, IR, and BR (preferably BR).

Silica is blended as a filler in the rubber composition according to the embodiment. As the silica, for example, wet silica such as wet-precipitated silica and wet-gelled silica is preferably used.

The nitrogen adsorption specific surface area of the silica is not particularly limited and may be, for example, 100 to 300 m²/g, 150 to 250 m²/g or 180 to 220 m²/g. The nitrogen adsorption specific surface area of the silica is the BET specific surface area measured in accordance with the BET method described in JIS K6430:2008.

The silica content is 80 to 140 parts by mass based on 100 parts by mass of the rubber component. When such a high amount of silica is used as the filler, the effect of improving the low heat generation property can be enhanced. The silica content based on 100 parts by mass of the rubber component is preferably 90 to 130 parts by mass, more preferably 100 to 120 parts by mass.

The filler may be silica alone, but another filler may be blended with silica. Examples of the other filler include carbon black and an inorganic filler, and carbon black is preferable.

The proportion of the silica in the filler is not particularly limited but is preferably 80 mass % or more, more preferably 90 mass % or more, further preferably 95 mass % or more, and may be 100 mass % (namely, silica alone).

When carbon black is blended as a filler with the silica, the carbon black content is not particularly limited but may be 20 parts by mass or less, 15 parts by mass or less, 10 parts by mass or less based on 100 parts by mass of the rubber component. Carbon black functions also as a colorant that colors the rubber composition black, and in this case, the carbon black content may be 3 to 10 parts by mass based on 100 parts by mass of the rubber component.

The carbon black is not particularly limited, and various known kinds can be used. Specific examples thereof include SAF grade (N100 series), ISAF grade (N200 series), HAF grade (N300 series), FEF grade (N500 series), and GPF grade (N600 series) (all are ASTM grade). Any one kind of the carbon black of the grades or a combination of two or more kinds thereof can be used.

In the rubber composition according to the embodiment, a thiuram-based vulcanization accelerator represented by the following general formula (1) (hereinafter referred to as thiuram disulfide (1)) is blended as a vulcanization accelerator.

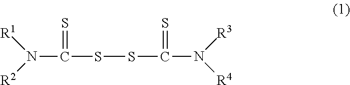

In the formula (1), R¹, R², R³, and R⁴ are each independently a hydrocarbon group having 12 to 20 carbon atoms and may contain one heteroatom or more. R¹ and R² and/or R³ and R⁴ may form a heterocyclic group together with the nitrogen atom to which they are bonded.

The hydrocarbon groups represented by R¹, R², R³, and R⁴ may be linear or branched, may contain a cyclic hydrocarbon group (for example, an alicyclic hydrocarbon group or an aryl group), may contain a heterocyclic group and may be saturated or unsaturated. Examples of the heteroatom include an oxygen atom and a nitrogen atom, and such a heteroatom may be contained as a substituent or may be contained in the main chain as in an ether bond, an ester bond or an amide bond. The number of the carbon atoms of each hydrocarbon group is preferably 12 to 18.

R¹ and R² may form a heterocyclic group together with the nitrogen atom to which they are bonded, and R³ and R⁴ may form a heterocyclic group together with the nitrogen atom to which they are bonded. When such a heterocyclic group is formed, the number of the carbon atoms is 24 to 40 in total of R¹ and R² or 24 to 40 in total of R³ and R⁴. Specific examples of the heterocyclic group include a pyrrolidine ring, a pyrrole ring, a piperidine ring, and the like, and —NR¹R² and —NR³R⁴ having the number of carbon atoms described above are each formed when one or more hydrocarbon groups are bonded as substituents to such a heterocyclic group.

In an embodiment, R¹, R², R³, and R⁴ are each independently preferably a monovalent saturated hydrocarbon group, more preferably an alkyl group such as a linear or branched dodecyl group, a linear or branched tridecyl group, a linear or branched tetradecyl group, a linear or branched hexadecyl group, a linear or branched heptadecyl group, and a linear or branched octadecyl group, further preferably a linear alkyl group.

The thiuram disulfide (1) content is 0.2 to 6 parts by mass based on 100 parts by mass of the rubber component. The thiuram disulfide (1) content based on 100 parts by mass of the rubber component is preferably 0.3 to 5.5 parts by mass, more preferably 0.5 to 5 parts by mass, further preferably 0.7 to 4 parts by mass.

The vulcanization accelerator may be the thiuram disulfide (1) alone, but another vulcanization accelerator may be used in combination with the thiuram disulfide (1). Examples of the other vulcanization accelerator include a sulfenamide-based vulcanization accelerator, a guanidine-based vulcanization accelerator, a thiazole-based vulcanization accelerator, and the like.

In an embodiment, the vulcanization accelerator preferably contains the thiuram disulfide (1) and a sulfenamide-based vulcanization accelerator. Examples of the sulfenamide-based vulcanization accelerator include N-cyclohexyl-2-benzothiazolesulfenamide, N-oxydiethylene-2-benzothiazolesulfenamide, N-(tert-butyl)-2-benzothiazolesulfenamide, and the like. Any one kind thereof may be used, or two or more kinds thereof may be used in combination.

When a sulfenamide-based vulcanization accelerator is used in combination, the content thereof is not particularly limited and may be, for example, 0.2 to 6 parts by mass, 0.5 to 5 parts by mass or 1 to 3 parts by mass based on 100 parts by mass of the rubber component. The mass ratio of the thiuram disulfide (1) content and the sulfenamide-based vulcanization accelerator content is not particularly limited, and for example, the thiuram disulfide (1)/sulfenamide-based vulcanization accelerator may be 1/6 to 4/1, 1/5 to 3/1 or 1/3 to 2/1.

An additive which is generally used for a rubber composition, such as a silane coupling agent, an oil, zinc oxide, stearic acid, an antioxidant, a wax, and a vulcanizing agent, may be blended in the rubber composition according to the embodiment in addition to the above components.

Examples of the silane coupling agent include sulfide silane coupling agents such as bis(3-triethoxysilylpropyl)tetrasulfide, bis(3-triethoxysilylpropyl)disulfide, bis(2-triethoxysilylethyl)tetrasulfide, bis(4-triethoxysilylbutyl)disulfide, bis(3-trimethoxysilylpropyl)tetrasulfide, and bis(2-trimethoxysilylethyl)disulfide, mercapto silane coupling agents such as 3-mercaptopropyltrimethoxysilane, 3-mercaptopropyltriethoxysilane, 3-mercaptopropylmethyldimethoxysilane, 3-mercaptopropyldimethylmethoxysilane, and mercaptoethyltriethoxysilane, and thioester group-containing silane coupling agents such as 3-octanoylthio-1-propyltriethoxysilane, 3-propionylthiopropyltrimethoxysilane, 3-hexanoylthio-1-propyltriethoxysilane, and 3-octanoylthio-1-propyltrimethoxysilane. Any one kind thereof or a combination of two or more kinds thereof can be used.

The silane coupling agent content is not particularly limited but is preferably 2 to 25 mass % of the silica amount, namely 2 to 25 parts by mass based on 100 parts by mass of the silica. The silane coupling agent content is more preferably 5 to 20 mass % of the silica amount.

The oil content is not particularly limited and may be, for example, 0 to 40 parts by mass, 3 to 30 parts by mass or 5 to 25 parts by mass based on 100 parts by mass of the rubber component.

The zinc oxide content is not particularly limited and may be, for example, 0 to 10 parts by mass, 0.5 to 5 parts by mass or 1 to 4 parts by mass based on 100 parts by mass of the rubber component.

The stearic acid content is not particularly limited and may be, for example, 0 to 10 parts by mass, 0.5 to 5 parts by mass or 1 to 4 parts by mass based on 100 parts by mass of the rubber component.

Examples of the antioxidant include various antioxidants such as amine-ketone-based, aromatic secondary amine-based, monophenol-based, bisphenol-based, and benzimidazole-based antioxidants, and any one kind thereof or a combination of two or more kinds thereof can be used. Of these, an aromatic secondary amine-based antioxidant is preferable, and a phenylenediamine-based antioxidant such as N-(1,3-dimethylbutyl)-N′-phenyl-p-phenylenediamine (6PPD), N,N′-bis(1,4-dimethylpentyl)-p-phenylenediamine (77PD), N-(1-methylheptyl)-N′-phenyl-p-phenylenediamine (8PPD), and N-(1,4-dimethylpentyl)-N′-phenyl-p-phenylenediamine (7PPD) is more preferable. The antioxidant content is not particularly limited and may be, for example, 0 to 10 parts by mass, 0.5 to 5 parts by mass or 1 to 4 parts by mass based on 100 parts by mass of the rubber component.

The wax content is not particularly limited and may be, for example, 0 to 10 parts by mass, 0.3 to 5 parts by mass or 0.5 to 3 parts by mass based on 100 parts by mass of the rubber component.

As the vulcanizing agent, sulfur is preferably used. The vulcanizing agent content is not particularly limited but is preferably 0.1 to 10 parts by mass, more preferably 0.5 to 5 parts by mass, further preferably 1 to 3 parts by mass, based on 100 parts by mass of the rubber component.

The rubber composition according to the embodiment can be produced by kneading using a generally used mixer such as a Banbury mixer, a kneader, and a roll according to a general method. That is, for example, by adding and mixing the additives excluding the vulcanizing agent and the vulcanization accelerator in the rubber component in a first mixing stage and next adding and mixing the vulcanizing agent and the vulcanization accelerator in the obtained mixture in a final mixing stage, a rubber composition can be prepared.

The rubber composition according to the embodiment can be used for various rubber members such as a tire, a vibration proof rubber, and a conveyor belt. The rubber composition is preferably for a tire. Examples of the tire include pneumatic tires of various sizes for various applications, such as tires of passenger vehicles and large-sized tires of trucks and buses. Regarding the applied part in a tire, the rubber composition can be applied to a part in a tire such as a tread, a sidewall, and a bead part.

In an embodiment, a tire including a rubber member (for example, a tread rubber, a sidewall rubber, or the like) produced with the rubber composition is produced as follows. The rubber composition is formed into a predetermined form, for example, by extrusion processing according to a general method. By assembling the formed material obtained with other members, a green tire is produced. By vulcanizing and forming the green tire, for example, at 140 to 180° C., a pneumatic tire can be produced.

The tire according to an embodiment has a tread rubber produced using the rubber composition. The structures of the tread rubber of a tire include a two-layer structure having a cap rubber and a base rubber and a single-layer structure in which both are combined. In the single-layer structure, the tread rubber is preferably formed with the rubber composition. In the two-layer structure, although the cap rubber on the outer side which comes into contact with the road surface is preferably formed with the rubber composition, both the cap rubber and the base rubber may be formed with the rubber composition.

### EXAMPLES

Examples of the invention are shown below, but the invention is not limited to these Examples.

The components used in the Examples and the Comparative Examples are as follows.
Modified SSBR 1: terminal modified with an alkoxy group and an amino group, “HPR350” manufactured by ENEOS Materials Corporation
Modified SSBR 2: “HPR840” manufactured by ENEOS Materials Corporation
Unmodified SSBR: “SL563” manufactured by ENEOS Materials Corporation
BR: “UBEPOL BR150B” manufactured by UBE Elastomer Co. Ltd.
Carbon black: “Seast KH” manufactured by TOKAI CARBON CO., LTD.
Silica: “Nipsil AQ” manufactured by TOSOH SILICA CORPORATION (nitrogen adsorption specific surface area of 205 m²/g)
Coupling agent 1: sulfide silane coupling agent, “Si69” manufactured by Evonik Industries
Coupling agent 2: thioester group-containing silane coupling agent, “NXT” manufactured by Momentive Performance Materials
Oil: “Process NC140” manufactured by ENEOS Corporation
Zinc oxide: “Zinc Oxide, No. 3” manufactured by MITSUI MINING & SMELTING CO., LTD.
Stearic acid: “Lunac 5-20” manufactured by Kao Corporation
Antioxidant 1: 77PD, “VULKANOX4030” manufactured by Lanxess AG
Antioxidant 2: 6PPD, “Nocrac 6C” manufactured by OUCHI SHINKO CHEMICAL INDUSTRIAL CO., LTD.
Antioxidant 3: 8PPD, “OZONONE 35” manufactured by Seiko Chemical Co., Ltd.
Sulfur: “Powder Sulfur” manufactured by Tsurumi Chemical Industry Co., ltd.
Vulcanization accelerator 1: N-cyclohexyl-2-benzothiazolesulfenamide, “Nocceler CZ-G” manufactured by OUCHI SHINKO CHEMICAL INDUSTRIAL CO., LTD.
Vulcanization accelerator 2: diphenylguanidine, “Nocceler D” manufactured by OUCHI SHINKO CHEMICAL INDUSTRIAL CO., LTD.
Vulcanization accelerator 3: tetramethylthiuram disulfide, “Nocceler TT-P” manufactured by OUCHI SHINKO CHEMICAL INDUSTRIAL CO., LTD.
Vulcanization accelerator 4: tetrabenzylthiuram disulfide, “Nocceler TBZTD” manufactured by OUCHI SHINKO CHEMICAL INDUSTRIAL CO., LTD.
Vulcanization accelerator 5: tetralaurylthiuram disulfide obtained by Synthetic Example 1 below (R¹ to R⁴═CH₃(CH₂)₁₀CH₂— in the formula (1)) Synthetic Example 1:

A solution obtained by dissolving 35.4 g of dilauryl amine in 300 ml of THF was prepared, and a solution obtained by dissolving 18.75 g of potassium hydroxide in 18.75 ml of water was added drop by drop. To the solution after the dropwise addition, 18.13 ml of carbon disulfide was added, and the mixture was stirred at room temperature. A saturated iodine methanol solution was added dropwise to the reaction mixture until the color of the reaction mixture did not become lighter anymore. Next, the reaction mixture was filtered, and the residue was purified by silica gel column chromatography to obtain the target purified material. The yield was 82 mass %. ¹³C-NMR analysis and mass spectrometry of the product after the purification were conducted, and it was found that tetralaurylthiuram disulfide was obtained.
Vulcanization accelerator 6: tetraoctadecylthiuram disulfide obtained by Synthetic Example 2 below (R¹ to R⁴═CH₃(CH₂)₁₆CH₂— in the formula (1)) Synthetic Example 2:

A solution obtained by dissolving 52.20 g of dioctadecyl amine in 500 ml of THF was prepared, and a solution obtained by dissolving 18.75 g of potassium hydroxide in 18.75 ml of water was added drop by drop. To the solution after the dropwise addition, 18.13 ml of carbon disulfide was added, and the mixture was stirred at room temperature. A saturated iodine methanol solution was added dropwise to the reaction mixture until the color of the reaction mixture did not become lighter anymore. Next, the reaction mixture was filtered, and the residue was purified by silica gel column chromatography to obtain the target purified material. The yield was 85 mass %. ¹³C-NMR analysis and mass spectrometry of the product after the purification were conducted, and it was found that tetraoctadecylthiuram disulfide was obtained.

The measurement and evaluation methods in the Examples and the Comparative Examples are as follows.

### (1) Hardness

The hardness was measured at 23° C. using a sample obtained by stacking three vulcanized rubber sheets having a thickness of 2 mm and using a type A durometer according to JIS K6253-3:2012. The values (points) of the changes in hardness are shown based on the value of Comparative Example 1-1 in Table 1 and on the value of Comparative Example 2-1 in Table 2.

### (2) Low Heat Generation Property

Using a vulcanized sample having a width of 5 mm, a length of 20 mm, and a thickness of 1 mm, the loss tangent tan δ was measured according to JIS K6394:2007 using rheospectrometer E4000 manufactured by UBM under the condition of a static strain (initial strain) of 10%, a dynamic strain of 1%, a frequency of 10 Hz, and a temperature of 60° C. (tensile method). The results are shown by indexes, where the value of Comparative Example 1-1 is regarded as 100 in Table 1 and the value of Comparative Example 2-1 is regarded as 100 in Table 2. As the index becomes smaller, tan δ is smaller, meaning that the sample does not easily generate heat, has excellent low heat generation property and thus has excellent low fuel efficiency performance as a tire.

### (3) Dispersibility

Using a vulcanized sample having a width of 5 mm, a length of 20 mm, and a thickness of 1 mm, the storage moduli (E′(0.1) and E′(10)) with the dynamic strains of 0.1% and 10% were measured using rheospectrometer E4000 manufactured by UBM under the condition of a temperature of 60° C., a frequency of 10 Hz, and a static strain (initial strain) of 10% (tensile method), and the Payne effect (6E′=E′(0.1)−E′(10)) was calculated. The results are shown by indexes, where the value of Comparative Example 1-1 is regarded as 100 in Table 1 and the value of Comparative Example 2-1 is regarded as 100 in Table 2. As the index becomes smaller, 6E′ becomes smaller, meaning that the dispersibility of the filler is excellent.

### First Experimental Example

Using a Banbury mixer, in accordance with the formulation (parts by mass) shown in Table 1 below, first, the agents to be blended excluding sulfur and the vulcanization accelerators were added to and kneaded in the rubber component in a first mixing stage (discharge temperature=155° C.). Next, sulfur and the vulcanization accelerators were added to and kneaded in the obtained kneaded material in a final mixing stage (discharge temperature=90° C.), and a rubber composition was thus prepared.

In Table 1, Comparative Example 1-1 was used as a standard composition, and the added amounts of the vulcanization accelerators were adjusted in such a manner that the hardnesses would become approximately the same as that of the standard composition. This is because a vulcanized rubber generally tends to have excellent low heat generation property as the hardness is higher, and the low heat generation properties were compared under the condition that the hardnesses, which affect the rigidity and the wearability, were the same.

Vulcanized rubber samples having a predetermined form were produced by vulcanizing the obtained rubber compositions at 160° C. for 30 minutes, and the hardnesses, the low heat generation properties, and the dispersibilities were measured and evaluated. The results are as shown in Table 1.

TABLE 1

| | Comp. | Comp. | Comp. | Comp. | Comp. | Comp. | Ex. | Ex. | Ex. | Ex. | Ex. | Ex. |
|---|---|---|---|---|---|---|---|---|---|---|---|---|
| | Ex. 1-1 | Ex. 1-2 | Ex. 1-3 | Ex. 1-4 | Ex. 1-5 | Ex. 1-6 | 1-2 | 1-1 | 1-3 | 1-4 | 1-5 | 1-6 |
| Formulation | | | | | | | | | | | | |
| (parts by mass) | | | | | | | | | | | | |
| Modified SSBR1 | 70 | 70 | 70 | 70 | — | 70 | 70 | 70 | 70 | 70 | 70 | 70 |
| Unmodified SSBR | — | — | — | — | 70 | — | — | — | — | — | — | — |
| BR | 30 | 30 | 30 | 30 | 30 | 30 | 30 | 30 | 30 | 30 | 30 | 30 |
| Carbon black | 5 | 5 | 5 | 30 | 5 | 5 | 5 | 5 | 5 | 5 | 5 | 15 |
| Silica | 100 | 100 | 100 | 75 | 100 | 100 | 100 | 100 | 100 | 100 | 100 | 90 |
| Coupling agent 1 | 10 | 10 | 10 | 7.5 | 10 | 10 | 10 | 10 | 10 | 10 | 10 | 9 |
| Oil | 20 | 20 | 20 | 20 | 20 | 20 | 20 | 20 | 20 | 20 | 20 | 20 |
| Zinc oxide | 2 | 2 | 2 | 2 | 2 | 2 | 2 | 2 | 2 | 2 | 2 | 2 |
| Stearic acid | 2 | 2 | 2 | 2 | 2 | 2 | 2 | 2 | 2 | 2 | 2 | 2 |
| Antioxidant 1 | 2 | 2 | 2 | 2 | 2 | 2 | 2 | 2 | 2 | 2 | — | — |
| Antioxidant 2 | — | — | — | — | — | — | — | — | — | — | 2 | 2 |
| Sulfur | 2 | 2 | 2 | 2 | 2 | 2 | 2 | 2 | 2 | 2 | 2 | 2 |
| Vulcanization | 2 | 2 | 2 | 2 | 2 | 2 | 2 | 2 | 2 | 2 | 2 | 2 |
| accelerator 1 | | | | | | | | | | | | |
| Vulcanization | 2 | — | — | — | — | — | 1.0 | — | — | — | — | — |
| accelerator 2 | | | | | | | | | | | | |
| Vulcanization | — | 0.1 | — | — | — | — | — | — | — | — | — | — |
| accelerator 3 | | | | | | | | | | | | |
| Vulcanization | — | — | 0.3 | — | — | — | — | — | — | — | — | — |
| accelerator 4 | | | | | | | | | | | | |
| Vulcanization | — | — | — | — | — | — | — | 0.8 | — | — | — | — |
| accelerator 5 | | | | | | | | | | | | |
| Vulcanization | — | — | — | 0.8 | 0.8 | 0.1 | 0.4 | — | 0.8 | 3 | 4 | 0.8 |
| accelerator 6 | | | | | | | | | | | | |
| Evaluation | | | | | | | | | | | | |
| Hardness | — | −1 | 0 | 1 | −1 | −2 | 0 | 0 | −1 | 0 | +1 | 0 |
| Low heat generation | 100 | 100 | 99 | 112 | 108 | 105 | 95 | 94 | 94 | 93 | 92 | 98 |
| property | | | | | | | | | | | | |
| Dispersibility | 100 | 85 | 82 | 90 | 93 | 85 | 74 | 74 | 71 | 73 | 75 | 79 |

Comparative Example 1-1 is the standard composition using sulfenamide-based and guanidine-based vulcanization accelerators in combination. Compared to Comparative Example 1-1, in Comparative Examples 1-2 and 1-3, in which the guanidine-based vulcanization accelerator was replaced with a thiuram-based vulcanization accelerator other than the thiuram disulfide (1), the dispersibility was improved, but no effect of improving the low heat generation property was observed. In Comparative Example 1-6, although the thiuram disulfide (1) was blended, the blended amount was low, and the low heat generation property was poor. In Comparative Example 1-4, although the specified amount of the thiuram disulfide (1) was blended, the blended amount of the silica was low, and the low heat generation property was poor. In Comparative Example 1-5, although the specific amount of the thiuram disulfide (1) was blended, the modified SSBR was not blended, and thus the low heat generation property was poor.

On the other hand, in Examples 1-1 to 1-6, in which the specific amount of the silica was blended in the modified SSBR and the thiuram disulfide (1) was blended, the dispersibility was improved significantly, and an effect of improving the low heat generation property was observed, compared to Comparative Example 1-1.

### Second Experimental Example

Rubber compositions were prepared in the same manner as in the first experimental example but according to the formulations (parts by mass) shown in Table 2 below. Using the obtained rubber compositions, the hardnesses, the low heat generation properties, and the dispersibilities were measured and evaluated in the same manner as in the first experimental example. The results are as shown in Table 2. Here, in Table 2, Comparative Example 2-1 was used as a standard composition, and the added amounts of the vulcanization accelerators were adjusted in such a manner that the hardnesses would become approximately the same as that of the standard composition.

TABLE 2

| | Comp. Ex. | Comp. Ex. | Comp. Ex. | | | | |
|---|---|---|---|---|---|---|---|
| | 2-1 | 2-2 | 2-3 | Ex. 2-1 | Ex. 2-2 | Ex. 2-3 | Ex. 2-4 |
| Formulation | | | | | | | |
| (parts by mass) | | | | | | | |
| Modified SSBR2 | 70 | 70 | 70 | 70 | 70 | 70 | 70 |
| BR | 30 | 30 | 30 | 30 | 30 | 30 | 30 |
| Carbon black | 5 | 5 | 5 | 5 | 5 | 5 | 5 |
| Silica | 120 | 120 | 120 | 120 | 120 | 120 | 120 |
| Coupling agent 2 | 12 | 12 | 12 | 12 | 12 | 12 | 12 |
| Oil | 20 | 20 | 20 | 20 | 20 | 20 | 20 |
| Zinc oxide | 2 | 2 | 2 | 2 | 2 | 2 | 2 |
| Stearic acid | 2 | 2 | 2 | 2 | 2 | 2 | 2 |
| Antioxidant 1 | — | — | — | 2 | — | — | — |
| Antioxidant 2 | — | — | — | — | — | — | 2 |
| Antioxidant 3 | 2 | 2 | 2 | — | 2 | 2 | — |
| Sulfur | 2 | 2 | 2 | 2 | 2 | 2 | 2 |
| Vulcanization | 2 | 2 | 2 | 2 | 2 | 2 | 2 |
| accelerator 1 | | | | | | | |
| Vulcanization | 2 | — | — | — | — | — | — |
| accelerator 2 | | | | | | | |
| Vulcanization | — | 0.1 | — | — | — | — | — |
| accelerator 3 | | | | | | | |
| Vulcanization | — | — | 0.3 | — | — | — | — |
| accelerator 4 | | | | | | | |
| Vulcanization | — | — | — | 0.8 | — | — | — |
| accelerator 5 | | | | | | | |
| Vulcanization | — | — | — | — | 0.8 | 3 | 4 |
| accelerator 6 | | | | | | | |
| Evaluation | | | | | | | |
| Hardness | — | 0 | 0 | 0 | 0 | +1 | +1 |
| Low heat generation | 100 | 98 | 99 | 92 | 93 | 91 | 91 |
| property | | | | | | | |
| Dispersibility | 100 | 89 | 87 | 70 | 70 | 71 | 69 |

The second experimental example is an example in which the kind of the modified SSBR, the silica content, the kind of the silane coupling agent, and the like were changed from those in the first experimental example. In the second experimental example, the influence of the difference in the vulcanization accelerators on the low heat generation property and the dispersibility was examined under the condition that the rubber hardnesses were approximately equivalent, as in the first experimental example. In Examples 2-1 to 2-4, in which the thiuram disulfide (1) was blended, the dispersibility was improved significantly, and an effect of improving the low heat generation property was observed compared to Comparative Example 2-1.

In this regard, the upper limits and the lower limits of the various numerical ranges described in the specification can be combined freely, and all the combinations should be regarded as being described as preferable numerical ranges in the present specification. Moreover, a numerical range “X to Y” means X or more and Y or less.

What is claimed is:

1. A rubber composition comprising:
a rubber component containing a modified solution-polymerized styrene butadiene rubber;
silica; and
a thiuram-based vulcanization accelerator represented by the following general formula (1), 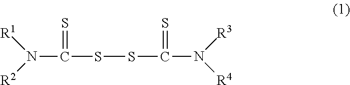
wherein in the formula (1), R¹, R², R³, and R⁴ are each independently a hydrocarbon group having 12 to 20 carbon atoms and may contain one heteroatom or more,
wherein R¹ and R² and/or R³ and R⁴ may form a heterocyclic group together with the nitrogen atom to which they are bonded, and
based on 100 parts by mass of the rubber component, the silica content is 80 to 140 parts by mass, and the thiuram-based vulcanization accelerator content is 0.2 to 6 parts by mass.

2. The rubber composition according to claim 1, wherein the modified solution-polymerized styrene butadiene rubber is a solution-polymerized styrene butadiene rubber into which at least one functional group selected from the group consisting of an amino group, a hydroxy group, an alkoxy group, a silyl group, an alkoxysilyl group, an epoxy group, and a carboxy group has been introduced.

3. The rubber composition according to claim 1, wherein 100 parts by mass of the rubber component contain 50 to 90 parts by mass of the modified styrene butadiene rubber and 10 to 50 parts by mass of at least one selected from the group consisting of a natural rubber, a synthetic isoprene rubber, and a butadiene rubber.

4. The rubber composition according to claim 1, wherein 100 parts by mass of the rubber component contain 50 to 90 parts by mass of the modified styrene butadiene rubber and 10 to 50 parts by mass of a butadiene rubber.

5. The rubber composition according to claim 1, wherein the silica content is 90 to 130 parts by mass based on 100 parts by mass of the rubber component.

6. The rubber composition according to claim 1, wherein R¹, R², R³, and R⁴ in the formula (1) each independently represent a linear or branched alkyl group having 12 to 18 carbon atoms.

7. The rubber composition according to claim 1, wherein R¹, R², R³, and R⁴ in the formula (1) each independently represent a linear alkyl group having 12 to 18 carbon atoms.

8. The rubber composition according to claim 1 which further comprises a sulfenamide-based vulcanization accelerator, wherein the sulfenamide-based vulcanization accelerator content is 0.2 to 6 parts by mass based on 100 parts by mass of the rubber component, and the mass ratio of the thiuram-based vulcanization accelerator content to the sulfenamide-based vulcanization accelerator content is 1/6 to 4/1.

9. A tire comprising a rubber member produced with the rubber composition according to claim 1.

10. A tire comprising a tread rubber produced with the rubber composition according to claim 1.
